(19) United States
(12) Patent Application Publication
(10) Pub. No.: US 2012/0124890 A1
(43) Pub. Date: May 24, 2012

(54) Arthropod Bioassay and Control Device

(76) Inventor: John H. Hainze, (US)

(21) Appl. No.: 13/300,241

(22) Filed: Nov. 18, 2011

Related U.S. Application Data
(60) Provisional application No. 61/415,628, filed on Nov. 19, 2010.
(60) Provisional application No. 61/447,845, filed on Mar. 1, 2011.

(51) Int. Cl. A01M 1/10

(52) U.S. Cl. 43/121

(57) ABSTRACT

An apparatus and method that replaces human subjects in laboratory and field testing of products intended to control blood-feeding arthropods and secondly a toxic bait device based on the same apparatus. The apparatus, because of its size and ease of use, can be used in all standard laboratory and field efficacy tests in place of human subjects for products intended to kill or repel arthropods thus providing continuity in test apparatus and methodology not currently possible.

### CROSS REFERENCE TO RELATED APPLICATIONS

This application claims the benefit of U.S. Provisional Application No. 61/415,628, filed Nov. 19, 2010, and U.S. Provisional Application No. 61/447,845, filed Mar. 1, 2011, which are incorporated by reference herein in its entirety for any purpose.

### BACKGROUND OF THE INVENTION

Arthropods, including insects, mites and ticks, are significant transmitters of debilitating disease globally resulting in losses of productivity and human suffering. Personal and area arthropod repellents, insecticides and acaricides are important parts of an effective strategy to prevent bites by disease vectors. Arthropod repellents and pesticides have, historically been evaluated using human subjects. These kinds of tests have the virtue of testing the product on or around the organism they are meant to protect. However, there are significant issues with human testing of repellents. They include:
Ethical considerations. There is a potential of contracting disease when technologies are tested in areas where arthropod-borne disease is endemic. The exposure of human subjects to arthropod bites results in discomfort. The exposure of human subjects, to arthropod repellent or pesticide ingredients may have unforeseen effects.
Variability in human attractiveness to arthropods contributes to variable test results and thus requires large numbers of subjects for an effective test.
Severe limitations on testing of new chemicals with limited toxicology data or human safety profiles.
Long test horizons as a result of time required in obtaining institutional review board and human studies review board approvals for studies.

Animal subjects have been utilized as an alternative but they also raise ethical concerns and do not always provide data similar to humans (Rutledge et al. 1994).

For these reasons, a testing method that does not involve living subjects is needed.

Human surrogate in-vitro tests have been developed for use in the laboratory (Rutledge et al. 1976, Klun et al. 2005). These tests utilize a membrane stretched over a warmed feeding well containing blood. Mosquito repellents are then applied to the membrane or cloth above the membrane. It is difficult to measure the duration of protection of a repellent in these tests because warmed blood degrades over time (Cockroft et al. 1998). Unfortunately, duration of repellency is a key feature of arthropod repellents.

Other in vitro repellent tests have been developed that do not utilize animals or blood. Examples of these tests include use of artificial blood for mosquitoes (Jahn et al. 2010), warm water containing feeding stimulants for mosquitoes (Klun et al. 2008), warm water reservoirs in a wind tunnel for mosquitoes (Sharpington et al. 2000) and a rotating warm drum for ticks (Dautel et al. 1999). While these tests provide important information on chemical performance, they are limited to testing personal, on-skin arthropod repellents in the laboratory. They cannot be used for field-testing or for area repellents or pesticide effects. The treated target area to which pest arthropods respond in these tests is quite small relative to human or animal subjects. And, the tests depart markedly from the efficacy tests using human subjects suggested by the US Environmental Protection Agency (1999) and the World Health Organization (2009a, 2009b). Therefore, a minimum second round of testing, is required to confirm real-world performance.

There are many arthropod traps in the patent literature and available commercially which may be used in testing area repellents in the field. Area repellents are products applied in the air or on surfaces in an area to protect humans or animals present in the area. They are not applied to the skin. Most traps like U.S. Pat. No. 4,907,366 issued to Balfour (1989) and U.S. Pat. No. 7,536,824 issued to Durand et al. (2009) use some means to kill the arthropods. This approach is not amenable to counting or identifying arthropods in determining the effectiveness of a repellent or pesticide. Certain other traps may be used for arthropod surveillance and simply trap but do not kill or destroy the insects (Service 1993). However, these traps, like killing traps, remove arthropods from the environment and this may impact results at subsequent stages of the test. This is particularly true when the target arthropod numbers are low. Furthermore, many of the traps, like U.S. Pat. No. 1,693,368 issued to Cherry (1927) utilize a fan to draw arthropods into a trap chamber. The airflow created by the fan has the possibility of disrupting the performance of certain area repellent products and thus artificially influencing test results. These traps also cannot be used to test personal on-skin repellents because there is no way to incorporate skin-like materials in a fan-based trap. Nor can they be used in laboratory tests. Therefore, there is no single test apparatus or method that can be used for testing both personal and area repellents and testing in the laboratory and in the field aside from the present invention.

Attractants are a necessary component of arthropod traps. Many different arthropod attractants are known which may be employed in traps and in this invention. U.S. Pat. No. 7,771,713 issued to Bernier et al. reviews the patent and scientific literature related to mosquito attractants and identifies several new ones. It is anticipated that many attractants could be used to enhance the performance of the present invention in addition to moisture, heat and carbon dioxide or even replacing one of these components. For example, Robinson US Publication No. 2003/0217503 mentions optional use of a candle to generate heat, carbon dioxide and light to attract mosquitoes to a killing surface.

There is a significant need for a method of evaluating the performance of blood-feeding arthropod control technologies without the use of live subjects. This invention satisfies that need for the full range of tests employed to investigate the efficacy of these technologies in both the laboratory and the field. The present invention provides continuity between tests in lab and field, standardized testing conditions that eliminate the variability encountered in use of live subjects and thus consistency of results not previously possible in the testing of blood-feeding arthropod repellents and pesticides.

A device that attracts blood-feeding arthropods for testing may also be utilized for controlling those same organisms. As mentioned above, attractant traps are used to capture and kill blood-feeding arthropods. However, they require disposal of trap contents on a regular basis and are generally too large, noisy or brightly lit for use indoors. In contrast, an arthropod bait eliminates the need for disposal of trap contents, would not require a noisy fan and may not require a light.

The combination of an insecticide and food has been used in scientific research and commercially to control a variety of arthropod pests including cockroaches, ants, filth flies and yellowjacket wasps. These insects may feed directly on a solid or liquid because they have mouthparts that allow chewing solids and lapping-up liquids.

Blood-feeding arthropods have mouthparts that pierce their hosts skin and allow them to then suck or sponge-up (depending on the particular arthropod) blood. Therefore, toxic bait for blood-feeding arthropods must be liquid and in a format that allows the arthropod to insert its mouthparts and imbibe the liquid bait.

Toxic baits are advantageous in that the pesticides may be containerized as opposed to conventional spraying and thus reduce impact on the environment and non-target species. Yoder U.S. Pat. No. 5,484,599 discloses use of attractive food bait containing a toxicant to kill mosquitoes and fire ants. Other attractants may be mixed in the bait but there are no provisions for more attractive materials that may be incorporated separately from the bait, like heat and carbon dioxide, thus limiting the range of attractant possibilities.

This food bait can be in liquid form. Kolibas U.S. Pat. No. 6,718,689 constructs a packet that contains a liquid food and toxicant as bait for mosquitoes. Mosquitoes would insert their proboscis into the packet and imbibe the toxic contents. This patent anticipates the use of mosquito attractants in the packet. However, again, there is no possibility of incorporating light, carbon dioxide, via gas canister or in the form of dry ice, or heat in this packet and they are not mentioned in the patent. The absence of these standard, most effective attractants limits the effectiveness of the Kolibas packet.

Fitsakis U.S. Pat. No. 5,359,808 describes the use of a bag or multiple compartment bags that emit water vapor and other attractants for Olive Fly, House Fly, Mediterranean Fly and Cherry Fly. The insecticide is applied on a strip or on the surface of the bag to kill flies that contact that bag. This application may be effective in an agricultural setting but the accessibility of insecticide on the surface of the device is not desirable in an urban or household setting where it may be contacted by children or pets. Further, there is also no capability to use heat or carbon dioxide as an attractant.

Foster et al U.S. Pat. No. 5,046,280 also uses an insecticide-covered surface. In this case, the insecticide-covered surface may contain an attractant and a sweet bait material. The bait is solid and intended for House Flies which can liquefy the bait to ingest it. This patent mentions the use of a plastic mesh to prevent contact with the insecticidal surface and the ability to open and close the device further limiting access to the insecticide. Similar design elements may be incorporated in the current invention to provide greater safety to users and to non-target organisms like honeybees. However, a solid bait would not be effective for blood feeding arthropods.

Lin et al U.S. Pat. No. 6,823,622 concerns a mosquito trap that utilizes separate yeast and bacterial fermentations in conjunction with heat to attract mosquitoes to a trap. This trap may include insecticide but there is no indication as to how it would be incorporated. Given that there are no provisions for mosquito feeding materials in the trap it would not be included as toxic bait and thus departs from the current invention, having some of the same disadvantages of traps as described above.

Muller et al (2008) employs liquid toxic baits in both a bait station and sprayed directly on foliage. The baits contain sugars and/or fruit juice, simulating floral nectar fed upon by mosquitoes in nature, and a toxicant, spinosad, to kill the mosquitoes. The bait ingredients serve to attract both male and female foraging mosquitoes. The present invention provides key host cues to a range of arthropods focusing on the arthropod stage or sex that feeds on blood and thus transmits disease. The authors state that these floral nectar-simulating baits would work best in arid regions that are poor in floral resources. The performance of these baits competes with the presence of flowers in an area. The sole attractant is moisture and sugar acts as a feeding stimulant. This bait lacks carbon dioxide, heat and other important attractants for host-seeking arthropods and is likely to be less effective.

Similarly, Xue et al. (2006) developed a liquid sugar bait for mosquitoes using boric acid or fipronil as toxicants. Carbon dioxide-producing packets were used as attractants. The authors found that these baits were not successful in reducing mosquito populations in backyard environments. The attractants in this bait was solely moisture and carbon dioxide. Heat was not used resulting in less attractiveness to host-seeking arthropods.

Kollars US Publication No. 2008/075324 uses toxic liquid baits to kill mosquitoes. A wide variety of insecticides are identified as potential ingredients in an aqueous formula that contains sugars. As in many of the other inventions and research findings above, this approach limits the use of the toxic bait, given the absence of host cues, such as heat and carbon dioxide, to arthropods that forage on plants. Further, there are no attractants that would draw arthropods to the bait from a distance, like carbon dioxide, so the approach is also limited to arthropods that actively forage for sugar solutions.

### SUMMARY OF THE INVENTION

The invention, an optimal combination of attractants, arrestants/feeding stimulants and structure provides a simple yet versatile means to measure the effect of efforts to control blood-feeding arthropods and, in a further embodiment, to control them. As a test method, it may be adapted for use in both the laboratory and in the field, a possibility previously unavailable to investigators. Because it uses basic host cues like heat, moisture and carbon dioxide, it may be used to discern the performance of products aimed at a variety of blood-feeding arthropods including species of mosquitoes, other biting flies, ticks and chiggers in a manner that duplicates human subject testing. In various versions, it may be used to evaluate arthropod repellents applied to the skin, area repellents used indoors, area repellents used outdoors and pesticides used both indoors and outdoors. This is the full range of tests recommended by the US Environmental Protection Agency (US EPA) (1999) and the World Health. Organization (WHO 2009a, 2009b) for repellents used on human skin and repellent and pesticide products used indoors and outdoors. There are no other non-living subject tests that can be used in all of these applications.

In all embodiments, the apparatus is comprised of a heated structure, which may be wrapped with a moist substrate on which arthropods will land or attach themselves, feed and on which they can be counted. The heat and moisture act as attractants and arrestants for blood-feeding arthropods. The moisture may also stimulate arthropods to insert their mouthparts and feed. However, other attractants or arrestants may be added depending on the nature of the test and the specific organism. This invention differs from arthropod traps in that it both attracts and encourages the arthropod to remain on the surface for a period of time, via the arrestant effect, for counting. It does not kill or otherwise remove arthropods from the environment unless adapted for use as a control device.

For laboratory tests of arthropod repellents that are applied to skin, a membrane is tightly attached over the moist substrate. A defined area of this membrane (typically 600 cm2) is treated with a defined amount of the experimental repellent (usually 1 gram). The structure itself should be similar in surface area to a human arm. This test article can then be introduced into a cage of arthropods at regular time intervals to determine the effective duration of the repellent by making counts of arthropods that land on or attach to the article within a proscribed time period. Or, it may be introduced into the cage with different dosages of repellent to, determine the effective dose. The apparatus is used in place of a human arm in the “arm-in-cage” test described in guidelines provided by the US Environmental Protection Agency (1999) and the World Health Organization (2009a).

The same structure is used for field tests of repellents applied to the skin. Presently, these tests are conducted using human volunteers who expose a forearm or lower leg for measuring repellent performance. In this invention, the exposed human limb is replaced by the apparatus described in the repellent laboratory test above. In the field, however, the apparatus must be supplied with at least one additional attractant. Carbon dioxide is an excellent attractant for field testing and is an effective attractant in the present invention. Carbon dioxide may be provided from dry ice, chemical reaction, microorganisms or from a pressurized cylinder. If a pressurized cylinder is used, the carbon dioxide is routed through a flow meter to control the rate of flow and through a tube that is attached to a fitting on the apparatus. Typical carbon dioxide flow rates for outdoor testing range from 200-500 ml/minute. The carbon dioxide flows into the apparatus and is discharged via one or more apertures in the base. The carbon dioxide serves to attract arthropods to the apparatus where they land or attach and may be counted. Counts are made at regular, defined intervals prior to and after use of an arthropod control product.

The membrane is not required for laboratory tests of area repellents. In this case, the apparatus consists of the heated structure wrapped with a moist substrate placed in the center of a testing chamber (e.g., 1.8 m×1.8 m×1.8 m per World Health Organization guidelines 2009b) and supplied with a source of carbon dioxide (e.g., a small pressurized cylinder). The carbon dioxide serves to attract arthropods to the apparatus. The flow rate is controlled by a flow meter. Carbon dioxide is routed from the tank into a chamber in the apparatus via a tube and enters through a fitting. The carbon dioxide then flows out from an aperture in the apparatus into the test chamber. Counts of arthropods that land on or attach to the moist substrate are made at defined intervals. Additional attractants may be added to the moist substrate or placed on or in the apparatus. Indoor field tests in homes are performed in a similar manner with the apparatus as described.

Outdoor field tests of area repellents or pesticides also do not require the membrane. Again, the apparatus is supplied with a source of carbon dioxide which may be dry ice, chemical reaction, microorganisms, or a pressurized cylinder as described above. Counts of arthropods landing on or attached to the substrate are made prior to discharging the arthropod control substance and then afterwards at defined intervals.

Counting may be done visually but technologies may be employed that use sensors to count flying insects as they approach or land on the target as in Hoffman et al. (2010) and may even identify mosquitoes by sound as in Batista et al. (2011).

In all cases, additional attractants may be added to the moist substrate or placed on or in the apparatus. The size and shape of the apparatus may also be varied as appropriate to the test and specific pest organism. In the case of tick field tests, for example, the apparatus may need to be moved through an area rather than left in a stationary position.

The apparatus described above may be adapted to improve the efficiency of arthropod capture in other traps. For example, certain mosquito traps rely on light and/or carbon dioxide to attract mosquitoes to a fan-generated air stream that drives them into a trap bag. In these traps, there is no specific means of drawing the mosquitoes to the fan. They are drawn to the area of the trap by the light or carbon dioxide but enter the trap only as a result of random movement around the trap itself. It is anticipated that applying the heat, moisture and/or other attractant substrate layers, as described herein, to the housing of the fan would draw mosquitoes more directly to the capturing air stream and increase the trapping efficiency. Other traps utilize combustion (e.g., often burning propane) to produce the carbon, heat and moisture that attracts mosquitoes. The present invention provides the same attractive elements without requiring combustion.

The apparatus described above may be adapted to serve as a blood-feeding arthropod control device. This involves incorporation of design elements that prevent humans and their pets from contacting the pesticide, addition of the pesticide itself and a liquid/bait reservoir. This control device is unique in that it's structure and combination of attractants, representing basic host cues (heat, moisture and a distance attractant/activator like carbon dioxide) for many blood-feeding arthropods, permits its use in a broad variety of environments (e.g., indoors and outdoors) and against a wide variety of blood-feeding arthropods.

The pesticide is incorporated in an aqueous solution or emulsion that is used to saturate the substrate or in dry form on the substrate to be activated or solubilized on contact with water or an aqueous solution. Access by humans or pets to the pesticide substrate may be restricted by covering the substrate with a membrane or mesh system or adding an outer package that may be opened when the product is in use. Closing the packaging would also reduce evaporation of the bait liquid when the product is not in use.

### BRIEF DESCRIPTION OF THE DRAWINGS

FIG. 1 is a perspective view of the control device for simulating on-skin repellent testing or use as an arthropod bait including the target structure with an aperture for attractant release, heating pad, moist substrate and membrane to which repellent is applied.

FIG. 2 is an elevational view of the control device with a water or liquid pesticide reservoir attached to it. Water flows to the moist substrate through a small aperture in the base of the reservoir.

FIG. 3 is an elevational view of the configuration of the device for area repellent testing or use as an arthropod bait in which carbon dioxide flows to the device from a carbon dioxide tank. In this illustration, no membrane is used since the area repellent is air-borne rather than applied to a surface (e.g., the skin).

### DETAILED DESCRIPTION

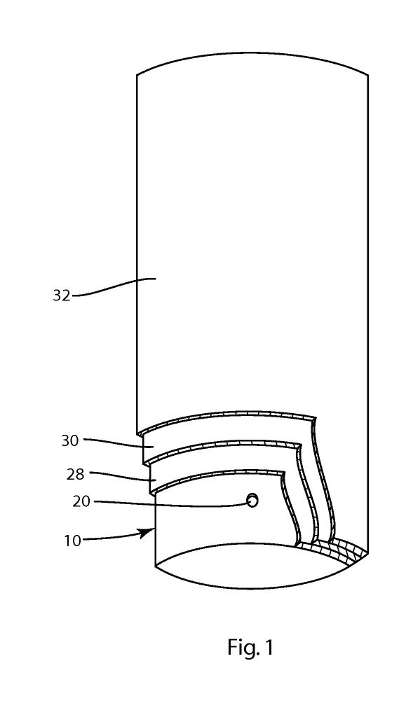

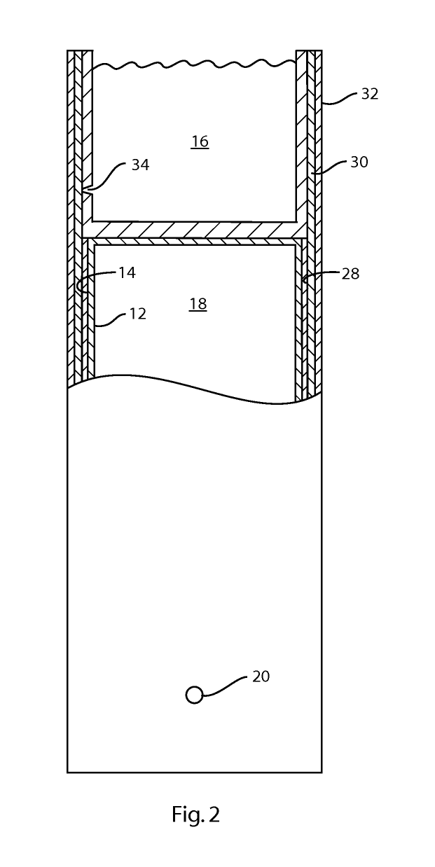

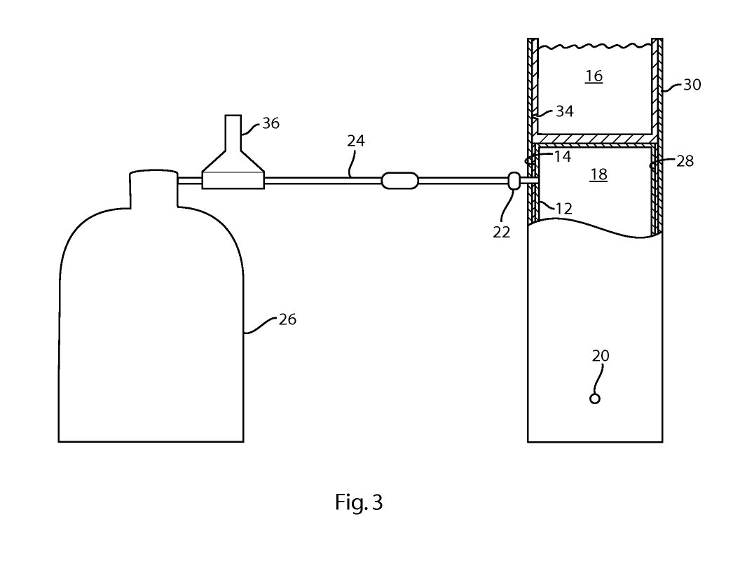

The base or target structure 10 of the apparatus when simulating a human limb is generally cylindrical or tubular in shape, though any shape may be used, and includes a wall defining an inner surface 12 and an outer surface 14. Metal or plastic pipe cut to an appropriate length may be used for structure 10 (see FIG. 1). The apparatus may be constructed so as to have an upper reservoir 16 and a lower chamber 18 (two sections of pipe for example as in FIG. 2). The upper reservoir 16 may contain water or a pesticide solution or pesticide emulsion, in the case of the bait, that may flow very gradually into the moist substrate wrapping the apparatus through one or more small holes 34 in the base of the reservoir. The upper reservoir 16 is not necessary if water or liquid pesticidal bait is added manually to the substrate at regular intervals. A reservoir is helpful for the use of this apparatus as an arthropod control device so that the device may continue to work unattended over an extended period of time. The lower chamber 18 may be used to discharge attractants into the environment through one or more apertures 20 at the top or base. A fitting 22 may be attached to the lower chamber 18 for attachment of a line 24 from a carbon dioxide, or other attractant, container or pressurized cylinder 26. (See FIG. 3). Flow of carbon dioxide gas through line 24 is controlled by a flow meter or regulator valve 36. If a pressurized carbon dioxide cylinder is not available, dry ice, chemical reactants, or carbon dioxide generating organisms may be placed inside the lower chamber 18 or in an external container.

Heat may be provided by wrapping the base structure with a heating pad 28, inserting a heating element into the walls of the rigid tubular structure or inserting a heating element into the chamber 18 of the tubular structure. The heat may be generated using electricity or chemically within the pad 28. Examples of chemical generation include the catalyzed rusting of iron and crystallization of sodium acetate. Microwavable heating pads may contain grains like wheat, buckwheat or flax. Electrical heating pads may be corded and utilize electrical current from outlets or from batteries with voltage converters. Electrical heating pads may also be powered directly by batteries. For certain tests, a larger target area may be desired. In these instances, a portable radiator like those used to heat rooms may be used as a base structure. This execution will require that an attractant reservoir be attached to the structure or that the attractant be dispensed directly from the exterior of the radiator. For laboratory tests, the structure may be modified to allow the circulation of heated fluid through the device to more accurately control its temperature. In a preferred embodiment, sufficient heat is generated so that the moist substrate reaches a temperature of about 30° C. to 45° C.

The moist substrate 30 must be a material that readily absorbs and retains water. A variety of natural or synthetic substances are available that meet these criteria. Examples of absorbent materials include woven and non-woven fabrics. Non-woven fabrics include materials such as felt and are composed of fibers bonded together by heat, pressure or entanglement. Examples of natural fibers include cellulosic fibers such as cotton and protein fibers such as silk or wool. Synthetic fibers may include materials such as polyesters, polyamides, polyurethanes and polyacrylics. Fibers that are not readily water absorbing may also be treated with materials that enhance their water absorbing capabilities.

An arrestant is a substance that stimulates an organism to stop locomotion. An attractant is a substance that draws organisms towards it.

Additional auxiliary attractants may be added to the moist substrate, to the attractant reservoir or placed on the exterior of the apparatus. Ingredients that generate attractants may also be added to the moist substrate or attractant reservoir. Many arthropod attractants have been identified including chemicals like carbon dioxide, lactic acid and octenol. Carbon Dioxide and Octenol have been shown to be attractive to both mosquitoes (Kline 1990) and ticks (McMahon et al. 2001, Sonenshine 1991). Wilson, in U.S. Pat. No. 4,818,526, identifies dimethyl disulfide and dibutyl succinate as mosquito attractants. Bernier et al., in U.S. Pat. No. 7,771,713, show that combinations of lactic acid, butanone and dimethyl disulfide act as mosquito attractants and may be used to replace carbon dioxide in traps. Food materials have also been demonstrated as mosquito attractants including honey extracts (Kline 1990), olive oil (Ikeshoji 1987) and Limburger cheese fractions (Knols 1997). All of these materials are related in some way to chemicals that are emanated from the host. Squalene is another example of a chemical found on host skin that is attractive to ticks (Yoder et al. 1999). Certain other arthopods are also attracted by pheromones produced by the arthropod itself. For example, ticks are attracted to aggregation pheromone components like benzaldehyde, methyl salicylate and o-nitrophenol, isobutyric acid and nonanoic acid (Schoni et al. 1984, Apps et al. 1988). In addition to chemical attractants, light and color may be used to increase the attractiveness of the apparatus. It is anticipated that all known arthropod attractants and those identified in the future have the potential to improve performance of this invention in certain circumstances.

Feeding stimulants may be incorporated in the liquid or substrate when the apparatus is used as a control device to increase consumption of the toxicant. Feeding stimulants vary by arthropod but, by example, may include sugars such as sucrose (Lang and Wallace 2008) or nucleotides such as adenosine triphosphate (ATP) (Klun et al. 2008). Feeding stimulants may also act to increase the arrestant effect of the moist substrate.

The membrane 32 used for personal repellents applied to skin must allow even distribution of the repellent formula or chemical. It is also useful if it allows arthropods, like mosquitoes, to be able to insert their mouthparts through it. This is critical in application of the apparatus as a bait control device. Collagen membranes used in artificial feeding of mosquitoes meet these requirements though other materials, will also be effective. Baudruche membrane, hemotek, sausage and silicone membrane were equally effective in in-vitro mosquito repellent tests (Dhenetra et al. 2005). Baudruche membranes have also been used successfully in feeding ticks. (Waladde et al. 1991). When the apparatus is used with toxicants as a control device, the membrane may be replaced or covered with a mesh sheet that both allows access to the moist substrate for feeding, prevents touching of the pesticide surface and restricts access to non-target organisms like honey bees.

Multiple additional membranes or other substrates might be applied to the surface of the apparatus that might contain arthropod repellents, arthropod toxicants, arthropod attractants or other functional materials both for purposes of specific product tests and for use of the invention as a control device. As anticipated in Klun et al. (2005) a treated cloth, such as treated clothing, may be wrapped over the membrane surface.

A variety of pesticides may be employed when the apparatus is used to control arthropods. Toxicants with a relatively higher degree of water solubility are preferred such as boric acid, sodium borate, dinotefuran, thiamethoxam or imidicoprid. Other toxicants with poor water solubility may be incorporated using surfactants to produce stable emulsions. Examples of additional potential pesticides include but are not limited to abamectin, acephate, acetamiprid, alpha-cypermethrin, bacillus thuringiensis, bendiocarb, bifenthrin, carbosulfan, chlorfenapyr, chlorpyrifos, chlorpyrifos methyl, clothianidin, cyfluthrin, cypermethrin, deltamethrin, d-phenothrin, d-trans allethrin, etofenprox, fipronil, hydramethylnon, indoxacarb, malathion, methomyl, nitenpyram, permethrin, pirimiphos-methyl, propetamphos, propoxur, pyrethrins, resmethrin, spinosad, sulfoxaflor, thiacloprid.

Pesticides may be provided to the substrate dissolved or emulsified in liquid from a reservoir or applied manually. They might also be incorporated in the substrate and solubilize when contacted by an aqueous solution. This aqueous solution could be supplied from a reservoir or applied manually.

Arthropods or the phylum Arthropoda comprise the greatest number of species of any phyla in the animal kingdom. Examples of the specific groups of blood-feeding arthropods that concern this invention include mosquitoes (Culicidae), blackflies (Simuliidae), sand flies (Phlebotominae), biting midges (Ceratopogonidae), horseflies (Tabanidae), tsetse flies (Glossinidae), stable flies (Muscidae), fleas (Siphonaptera), lice (Anoplura), triatomine bugs (Triatominae), chigger mites (Trombiculidae), soft ticks (Argasidae) and hard ticks (Ixodidae). Specific arthropod genera of interest within these groups include: Culex, Aedes, Psorophora, Wyeomyia, Mansonia, Coquilletidia or Anopheles mosquitoes; Simulium, Cnephia, Prosimulium and Austrosimulium blackflies; Phlebotomus, Sergentomyia and Lutomyia sand flies; Culicoides, Forcipomyia, Austroconops and Leptoconops biting midges; Chrysops, Silvius, Tabanus, Hybomitra and Haematopota horseflies and deer flies; Glossina tsetse flies; Stomoxys stable flies; Cediopsylla, Ceratophyllus, Dasypsyllus, Diamanus, Hoplopsyllus, Xenopsylla, Monopsyllus, Nosopsyllus, Orchopeas, Pulex, Hystrichopsylla, Leptosylla, Echidnophaga, Ctenocephalides and Tunga fleas; Leptotrombidium, Euschoengastia, Trombicula, Eutrombicula chigger mites; Ixodes, Haemaphysalis, Amblyomma, Dermacentor, Anocentor, Hyalomma, Nosomma, Rhipicephalus, Boophius and Margaropus hard ticks; Argas, Ornithodoros and Otobius soft ticks; Pthirus and Pediculus lice; Triatoma, Panstrongylus and Rhodinius triatomine bugs.

### EXAMPLES

Non-limiting examples that illustrate the invention.

### Example 1

Table 1 illustrates the arrestant effect of the moist substrate versus the substrate without water and a plastic surface. Data are from a laboratory test in which the invention apparatus was inserted into 3 cages containing 43-59 Anopheles gambiae mosquitoes each. The number of seconds that 15 individual mosquitoes resided on the surface of the apparatus was timed by stop watch.

TABLE 1
Mean Residence Time (seconds) on Substrates
for A. gambiae (n = 15)

| Warm Plastic | Warm Dry Cloth | Warm Wet Cloth |
|---|---|---|
| Surface | Subtrate | Substrate |
| 11.9 | 17.5 | 96.1 |

### Example 2

Table 2 illustrates the use of the test for laboratory testing of blood-feeding arthropod repellents. DEET, a standard arthropod repellent chemical, was diluted to 10% in ethanol. One gram of this solution was applied to 600 cm2 of the membrane. The membrane was wrapped around the moist substrate. The invention apparatus was inserted into a cage of 100 Anopheles stephensi mosquitoes at periodic intervals and the number landing was counted. Two lands or one land in each of two consecutive time frames is considered the end of repellent duration.

TABLE 2
10% DEET Repellency Duration versus A. stephensi

| | 1 Hour | 2 Hours | 3 Hours | 3.5 Hours |
|---|---|---|---|---|
| Number of Lands | 0 | 0 | 0 | 2 |

### Example 3

Table 3 illustrates the use of the test for field testing of blood-feeding arthropod repellents. Two commercial arthropod repellent products were tested on the membrane of the apparatus. These products contained 7% DEET and 7% Picaridin respectively. One milliliter of each was applied to the membrane. The number of mosquitoes landing were counted at periodic intervals. Testing was conducted in the campground of a state recreation area. Aedes vexans, Aedes triseriatus and Aedes trivittatus mosquitoes were present.

TABLE 3
7% DEET and 7% Picaridin Repellency -
Number of Mosquitoes Landing

| Time | Control (no repellent) | 7% DEET | 7% Picaridin |
|---|---|---|---|
| 1.5 Hours | 7 | 0 | 0 |
| 2 Hours | 3 | 0 | 0 |
| 2.5 Hours | 13 | 1 | 0 |
| 3 Hours | 8 | 0 | 0 |
| 3.5 Hours | 10 | 1 | 2 |

### Example 4

Table 4 illustrates the use of the apparatus as a control device. In this example, the substrate is saturated with 100 milliliters of a 0.05% solution of dinotefuran insecticide. The wet substrate is then covered completely with a membrane. The apparatus is placed inside a cage (46×46×51 cm) containing 75 female Anopheles stephensi mosquitoes. The mosquitoes were 12 days past emergence from the pupal stage and had been fed on a sucrose in water solution. The heating pad was turned on once the apparatus was inserted in the cage.

TABLE 4

| | Percent Mortality Over Time | | | |
|---|---|---|---|---|
| Treatment | 0.25 Hours | 1.25 Hours | 2.25 Hours | 3.25 Hours |
| Control | 0 | 1 | 2 | 4 |
| 0.05% | 15 | 34 | 60 | 71 |
| Dinotefuran | | | | |

### Example 5

This example illustrates the attractiveness of the apparatus as compared to a human arm. Forty female Anopheles stephensi mosquitoes were placed inside a cage (46×46×51 cm). The mosquitoes had not been fed for 12 hours prior to the test. Three cages of these mosquitoes were used in the experiment. The apparatus, consisting of heating pad, moist substrate and membrane, or a human arm was inserted into a cage for a one-minute interval and the number of mosquito landings was counted. Left arm and right arm and two constructions of the invented apparatus were each inserted on two occasions in each of the three cages. Therefore, tests on each arm and each apparatus were replicated six times.

There were an average of 15.8 lands per minute on the human arms and 16.6 lands per minute on the apparatus.

### Example 6

This example illustrates the similarity of performance of the apparatus compared to human arms in a test of mosquito repellency, the laboratory arm-in-cage test. A 25% diethyl toluamide (DEET) in ethanol solution was applied to the arms of 4 human subjects and compared to the same solution applied to the apparatus described in this invention at a rate of 1 ml per 600 cm surface area. Four mosquito cages each contained 200 female Aedes aegypti mosquitoes. The apparatus and volunteer arms were inserted in the cage at 30-60 minute intervals until two bites occurred or a single bite occurred in two successive intervals. The elapsed time was considered the effective repellent time.

The human arm, with repellent, effectively repelled mosquitoes for an average of 315 minutes. The apparatus, with repellent, effectively repelled mosquitoes for an average of 300 minutes.

The above description and Examples 1-6 illustrate an apparatus and method for measuring the effectiveness of blood-feeding arthropod control products comprising 1) a target structure of variable size and shape on which arthropods land or attach and can be counted, 2) a heat source, 3) a wet substrate wrapped around the heat source, 4) a membrane or other wrapping material that may represent human skin to which an arthropod repellent may be applied, 5) a carbon dioxide source that causes carbon dioxide to be emanated from the structure and/or other arthropod attractants examples of which include but are not limited to lactic acid, dimethyl sulfide, dimethyl succinate, butanone, squalene, benzaldehyde, methyl salicylate and o-nitrophenol, isobutyric acid and nonanoic acid or octenol. The carbon dioxide, heat and moisture serve to attract blood-feeding arthropods to the structure. The warm, moist membrane serves to arrest the arthropod to better enable counting. These basic elements, because of their size and ease of use, can be used in all standard laboratory and field efficacy tests in place of human subjects for products intended to kill or repel arthropods thus providing continuity in test apparatus and methodology not currently possible. And, further considering that the heat, moisture and carbon dioxide emission rate are easily controlled, therefore providing greater consistency in results than can currently be obtained with human subjects.

The same target structure, heat source, wet substrate, attractants and wrapping material may also serve as an arthropod control device. In this further application, the substrate is saturated with liquid containing an insecticide and, optionally, feeding stimulants. The device attracts blood-feeding arthropods that obtain a lethal dose of toxicants by inserting their mouthparts through the wrapping material and imbibing the dissolved toxicant. This optimal combination of basic attractant elements and device structure enable use of the product in a wide variety of settings including both indoors and outdoors.

Accordingly, in one embodiment there is provided a blood-feeding arthropod control apparatus, comprising a target structure having a wall defining a chamber, an inner surface and an outer surface; a heat source for heating at least a portion of said target structure; and a moist substrate having an inner surface in contact with the outer surface of said target structure, and an outer surface;

wherein the heat and moisture serve to attract blood-feeding arthropods and the warm, moist membrane serves to arrest the arthropods.

In another embodiment, the apparatus, further includes a membrane having an inner surface in contact with the outer surface of said moist substrate, and an outer surface.

In yet another embodiment, said membrane is selected from the group consisting of a collagen membrane, baudruche membrane, hemotek membrane, sausage membrane and silicone membrane.

In still another embodiment, the apparatus further includes an auxiliary arthropod attractant emanating from said chamber, and wherein said auxiliary arthropod attractant is carbon dioxide.

In another embodiment, the apparatus further includes an auxiliary arthropod attractant emanating from said moist substrate, wherein said auxiliary arthropod attractant is selected from the group consisting of lactic acid, octenol, dimethyl disulfide, butanone, olive oil, squalene, benzaldehyde, methyl salicylate, o-nitrophenol, isobutyric acid and nonanoic acid.

In another embodiment, the apparatus further includes a liquid reservoir in contact with said moist substrate, wherein said liquid reservoir contains a liquid selected from the group consisting of water, a pesticide-containing solution, and a pesticide-containing emulsion.

In yet another embodiment, said target structure is a rigid, elongated, hollow tubular member, said heat source is a heating pad wrapped around said tubular member, said moist substrate is wrapped around said heating pad and further including a source of carbon dioxide communicating with the chamber of said tubular member, and an aperture formed through the wall of said tubular member, said heating pad, and said moist substrate to permit said carbon dioxide to emanate from said chamber.

I claim:

1. A blood-feeding arthropod control apparatus, comprising:
a target structure having a wall defining a chamber, an inner surface and an outer surface;
a heat source for heating at least a portion of said target structure; and
a moist substrate having an inner surface in contact with the outer surface of said target structure, and an outer surface;
wherein the heat and moisture serve to attract blood-feeding arthropods and the warm, moist membrane serves to arrest the arthropods.

2. The apparatus of claim 1, further including a membrane having an inner surface in contact with the outer surface of said moist substrate, and an outer surface.

3. The apparatus of claim 2 wherein said membrane is selected from the group consisting of a collagen membrane, baudruche membrane, hemotek membrane, sausage membrane and silicone membrane.

4. The apparatus of claim 1 further including an auxiliary arthropod attractant emanating from said chamber.

5. The apparatus of claim 4 wherein said auxiliary arthropod attractant is carbon dioxide.

6. The apparatus of claim 1 further including an auxiliary arthropod attractant emanating from said moist substrate.

7. The apparatus of claim 6 wherein said auxiliary arthropod attractant is selected from the group consisting of lactic acid, octenol, dimethyl disulfide, butanone, olive oil, squalene, benzaldehyde, methyl salicylate, o-nitrophenol, isobutyric acid and nonanoic acid.

8. The apparatus of claim 1 further including a liquid reservoir in contact with said moist substrate.

9. The apparatus of claim 8 wherein said liquid reservoir contains a liquid selected from the group consisting of water, a pesticide-containing solution, and a pesticide-containing emulsion.

10. The apparatus of claim 1 wherein said target structure is a rigid, elongated, hollow tubular member.

11. The apparatus of claim 10 wherein said heat source is a heating pad wrapped around said tubular member.

12. The apparatus of claim 11 wherein said moist substrate is wrapped around said heating pad.

13. The apparatus of claim 12 further including a source of carbon dioxide communicating with the chamber of said tubular member, and an aperture formed through the wall of said tubular member, said heating pad, and said moist substrate to permit said carbon dioxide to emanate from said chamber.

14. The apparatus of claim 13 further including a liquid reservoir in contact with said moist substrate.

15. The apparatus of claim 14 wherein said liquid reservoir contains a liquid selected from the group consisting of water, a pesticide-containing solution, and a pesticide-containing emulsion.
